(19) United States
(12) Patent Application Publication
(10) Pub. No.: US 2002/0105936 A1
(43) Pub. Date: Aug. 8, 2002

(54) Multicode-based CDMA communication system for simultaneously performing voice communication and data communication

(75) Inventor: Jinichi Aoki, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/062,517

(22) Filed: Feb. 5, 2002

(30) Foreign Application Priority Data
Feb. 6, 2001 (JP) 2001-029610

(51) Int. Cl. H04B 7/216

(52) U.S. Cl. 370/342; 370/441

(57) ABSTRACT

A multicode-based CDMA communication system is disclosed for simultaneously performing a voice communication and a data communication. When PIWF receives packet data from ISP to a personal computer while a telephone connected to SU and a telephone connected to LS are communicating a voice through SU, WSC assigns a multicode (a plurality of spread codes) for the packet data based on the amount of packet data for the personal computer, received by PIWF, and the availability of a radio channel, and notifies SU of the assigned multicode. Then, WSC transmits the packet data received from ISP through PIWF to SU using the assigned multicode as packet data for the personal computer. SU and WSC simultaneously perform a voice communication and a data communication using the multicode.

### BACKGROUND OF THE INVENTION

1. Field of the Invention

The present invention relates to a CDMA communication system and method for communicating between a radio base station and a subscriber unit in accordance with a CDMA communication scheme.

2. Description of the Related Art

In recent years, a system called a wireless local loop (WLL) has been used as a substitute for a normal wired communication system which requires wired lines to all subscriber units. WLL refers to a system which employs radio transmissions on access transmission paths from node devices to subscribers to provide services equivalent to those in wired communication systems. As compared with the wired communication systems, the WLL is characterized by a smaller amount of initial investment, the construction available in a short term, the ability to flexibly accommodate variations in demand, a high resistance to accidents, and the like.

A presently proposed CDMA-WLL system employs a CDMA (Code Division Multiple Access) communication method which is immune to interference and disturbance as an access multiplexing method between subscriber units and a radio base station.

This CDMA communication method involves spreading a desired user signal using a spread code on the transmission side for transmission, and despreading a received signal using the same spread code as that used on the transmission side to recover the original user signal on the reception side.

Since the CDMA communication method allows a plurality of transmitters to spread their signals using different spread codes having orthogonality to one another, and a recipient to identify respective communications by selecting a spread code for use in despreading, the same frequency band can be shared by a plurality of communications.

Other than the foregoing CDMA-WLL system, there is a mobile communication system which permits a subscriber unit to be a mobile station that can be freely movable, as a CDMA communication system which employs a CDMA communication method for connections between subscriber units and radio base stations.

In such conventional CDMA communication systems, since a subscriber unit such as a mobile station, a fixed subscriber station and the like is assigned only one spread code, the subscriber unit cannot receive or originate a data call during a telephone call, and cannot receive or originate a voice call during a data communication. In other words, a subscriber unit cannot receive a data call or a voice call during a voice communication or during a data communication, and cannot originate a data call or a voice call during a voice communication or during a data communication.

For this reason, in the conventional CDMA communication system, when the user wishes to start a data communication during a voice communication or wishes to start a voice communication during a data communication, the voice communication or data communication must be once disconnected before a data communication or a voice communication is newly established as a new call. Also, for simultaneously performing a voice communication and a data communication, two subscriber units such as mobile terminals, fixed subscriber units or the like must be prepared to establish two calls.

### SUMMARY OF THE INVENTION

It is an object of the present invention to provide a CDMA communication system and method which are capable of simultaneously performing a voice communication and a data communication in a single call.

To achieve the above object, the CDMA communication system according to the present invention comprises a radio base station, a subscriber unit for performing CDMA-based radio transmission/reception with the radio base station, and a controller for connecting a call between the subscriber unit and the controller through the radio base station to perform a voice communication or a data communication.

When the controller receives a data communication to the subscriber unit while the subscriber unit is engaged in a voice communication, the controller assigns to the data communication a spread code different from a spread code used in the voice communication. Then, the controller notifies the subscriber unit of the assigned spread code, so that the subscriber unit communicates data using the assigned spread code. When the controller receives a notice from the subscriber unit informing that the subscriber unit is going to perform a data communication while it is engaged in a voice communication, the controller assigns to the data communication a spread code different from a spread code used in the voice communication. Then, the controller notifies the subscriber unit of the assigned spread code, so that the subscriber unit communicates the data using the assigned spread code. Further, when the subscriber unit receives a voice communication while it is engaged in a data communication, the controller assigns to the voice communication a spread code different from a spread code used in the data communication. Then, the controller notifies the subscriber unit of the assigned spread code, so that the subscriber unit communicates a voice using the assigned spread code. Further, when the controller receives a notice from the subscriber unit informing that the subscriber unit is going to perform a voice communication while it is engaged in a data communication, the controller assigns to the voice communication a spread code different from a spread code used in the data communication. Then, the controller notifies the subscriber unit of the assigned spread code, so that the subscriber unit communicates the voice using the assigned spread code.

When the subscriber unit is going to perform a data communication while it is engaged in a voice communication, the subscriber unit notifies the controller that it wishes to perform a data communication, and communicates the data using a spread code assigned by the controller. Also, when the subscriber unit is notified of a spread code for a data communication from the controller while it is engaged in a voice communication, the subscriber unit communicates data using the notified spread code. Further, when the subscriber unit is going to perform a voice communication while it is engaged in a data communication, the subscriber unit notifies the controller that it wishes to perform a voice communication, and communicates the voice using a spread code assigned by the controller. Further, when the subscriber unit is notified of a spread code for a voice communication from the controller while it is engaged in a data communication, the subscriber unit communicates a voice using the notified spread code.

According to the present invention, when a data communication is newly started while a voice communication has been in progress between the subscriber unit and controller, or when a voice communication is newly started while a data communication has been in progress between the subscriber unit and controller, a spread code different from a previously used spread code is assigned to start a new communication, so that a voice communication and a data communication can be simultaneously performed in a single call session.

Also, in the present invention, the controller may determine the number of spread codes for a data communication based on the amount of packet data to be transmitted, and the availability of a radio channel.

The above and other objects, features and advantages of the present invention will become apparent from the following description with reference to the accompanying drawings which illustrate examples of the present invention.

### BRIEF DESCRIPTION OF THE DRAWINGS

FIG. 1 is a block diagram illustrating the configuration of a CDMA communication system according to an embodiment of the present invention;

FIG. 2 is a functional block diagram illustrating the internal configuration of subscriber unit (SU) 1 in FIG. 1;

FIG. 3 is a functional block diagram illustrating the internal configuration of wireless service controller (WSC) 3 in FIG. 1;

FIG. 4 is a functional block diagram illustrating the internal configuration of packet interworking function (PIWF) 6 in FIG. 1;

FIG. 5 is a diagram showing a method of specifying a communication code in a radio section between SU 1 and BTS 2 and exemplary transmission rates;

FIG. 6 is a diagram illustrating an exemplary control sequence between SU 1 and WSC 3;

FIG. 7 is a flow chart for describing the operation of WSC 3; and

FIG. 8 is a flow chart for describing the operation of SU 1.

### DETAILED DESCRIPTION OF THE PREFERRED EMBODIMENTS

Generally speaking, a CDMA communication system according to the present invention assigns different spread codes (codes) to a voice communication and a data communication, respectively, and uses a plurality of spread codes (multicode) in a single call to permit simultaneous performance of a voice communication and a data communication.

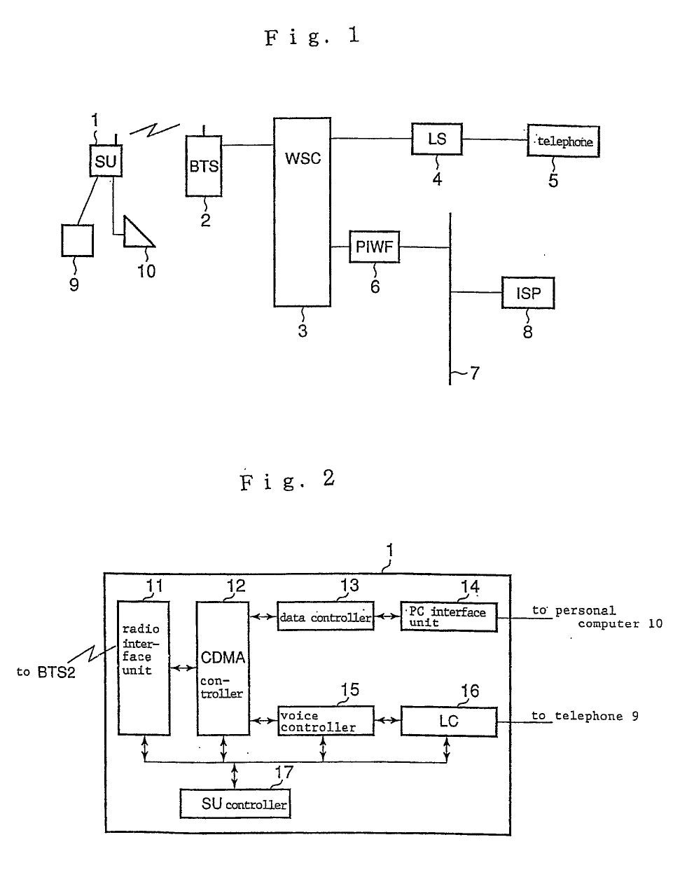

FIG. 1 illustrates a CDMA communication system according to one embodiment of the present invention which relies on the multicode to permit the simultaneous performance of a voice communication and a data communication in a single call.

As illustrated in FIG. 1, the CDMA communication system of this embodiment comprises subscriber unit (SU) 1; base transceiver station (BTS) 2; wireless service controller (WSC) 3; local switch (LS) 4; and packet interworking function (PIWF) 6.

In FIG. 1, CDMA-based radio transmission/reception is in progress between SU 1 and BTS 2, wherein telephone 9 and personal computer 12 are connected to SU 1. WSC 3 performs transmission/reception of data and voice data, other than a voice to BTS 2, and a data call is connected to PIWF 6, while a voice call is connected to LS4. Telephone 5 is a subscriber telephone connected under LS 4. PIWF 6 is connected to WSC 3 to receive packet data from Internet 7 and transmit the packet data to WSC 3, and vice versa. Internet service provider (ISP) 8 is responsible for processing involved in connecting general subscriber units to Internet 7.

FIG. 2 is a functional block diagram illustrating the internal configuration of SU 1. SU 1 comprises radio interface unit 11; CDMA controller 12; data controller 13, PC (personal computer) interface unit 14; voice controller 15; line circuit (LC) 16; and SU controller 17.

In SU 1, a data call arrival message in a voice communication is separated and analyzed by CDMA controller 12 which notifies the result of analysis to personal computer 10. A response to the data call arrival message from personal computer 10 is received by data controller 13, and transmitted to BTS 2 through CDMA controller 12.

For originating a data call during a voice communication, a request from personal computer 10 is received by data controller 13, and BTS 2 is notified of the data call origination through CDMA controller 12.

A voice call arrival message during a data communication is separated and analyzed by CDMA controller 12, and forwarded to telephone 9 through voice controller 15 and LC 16 for ringing telephone 9. A response from telephone 9 is detected by LC 16, and transmitted to BTS 2 through voice controller 15 and CDMA controller 12.

A voice call originated from telephone 9 during a data communication is detected by LC 16, and sent to BTS 2 through voice controller 15 and CDMA controller 12.

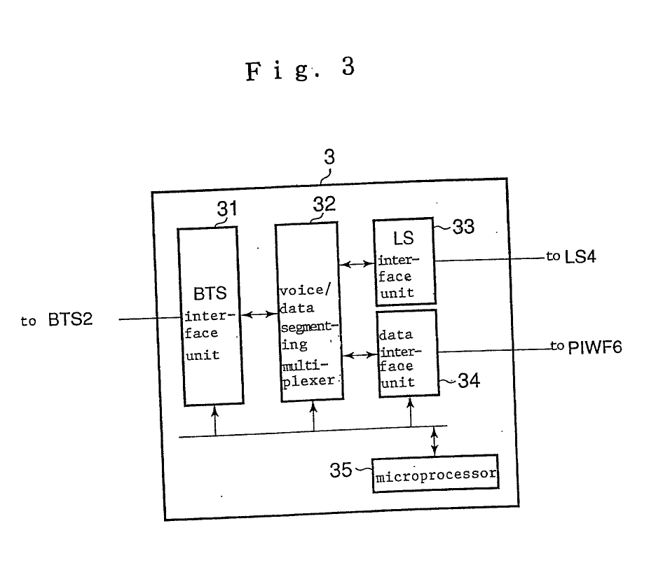

FIG. 3 is a functional block diagram illustrating the internal configuration of WSC 3 in FIG. 1. WSC 3 comprises BTS interface unit 31; voice/data segmenting multiplexer 32; LS interface unit 33; data interface unit 34; and microprocessor 35.

When SU 1 is engaged in a voice communication, a data call arrival message to personal computer 10 is detected by data interface unit 34 and transmitted to SU 1. A response to the data call arrival message from SU 1 is received by data interface unit 34, and transmitted to microprocessor 35.

When a data call is originated from personal computer 10 while SU 1 is engaged in a voice communication, a request from personal computer 10 is received by data interface unit 34, and transmitted to microprocessor 35.

When SU 1 is engaged in a data communication, a voice call incoming signal to telephone 9 is detected by LS interface unit 33, and transmitted to microprocessor 35. A call message to telephone 9 is transmitted to SU 1 through data interface unit 34. A response from SU 1 is detected by data interface unit 34, and transmitted to LS4 through LS interface unit 33.

When SU 1 is engaged in a data communication, a signal originated from telephone 9 is detected by data interface unit 34, and transmitted to LS 4 through LS interface unit 33.

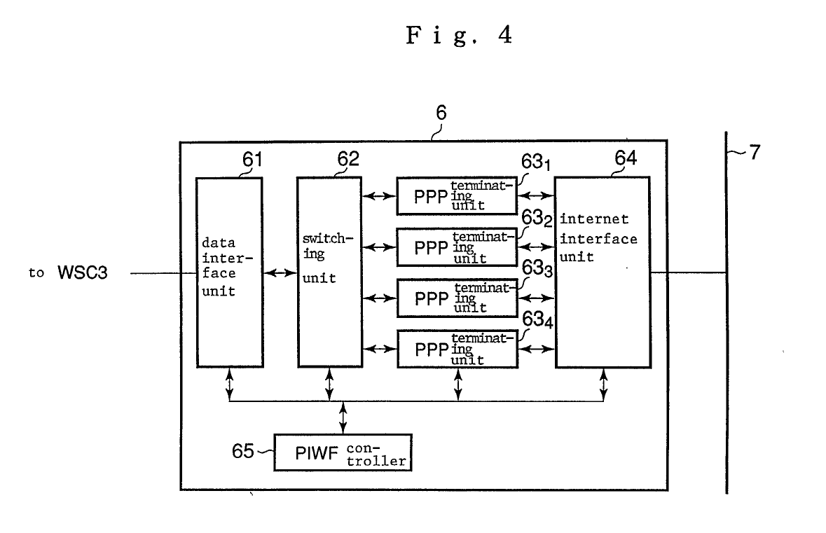

FIG. 4 is a functional block diagram illustrating the internal configuration of PIWF 6 in FIG. 1. PIWF 6 comprises data interface unit 61; switching unit 62; PPP (Point-to-Point Protocol) terminating units 63; Internet interface unit 64; and PIWF controller 65.

A packet data origination message from personal computer 10 is detected by data interface unit 61, and transmitted to PIWF controller 65. PIWF controller 65 selects PPP terminating unit 63 corresponding to an IP address associated with a mobile identification number (MIN) of SU 1, once terminates packet data from personal computer 10 at PPP terminating units 631-634, counts the numbers of transmitted and received packet data, and transmits the packet data to Internet 7 through Internet interface unit 64.

A packet data arrival message from ISP 8 to personal computer 10 is detected by Internet interface unit 64, and transmitted to PIWF controller 65. PIWF controller 65 selects PPP terminating unit 63 corresponding to an MIN number of SU 1 from the IP address of personal computer 10, once terminates packet data from ISP 8 in PPP terminating unit 63, counts the numbers of transmitted and received packet data, and transmits the packet data to WSC 3 through data interface unit 61.

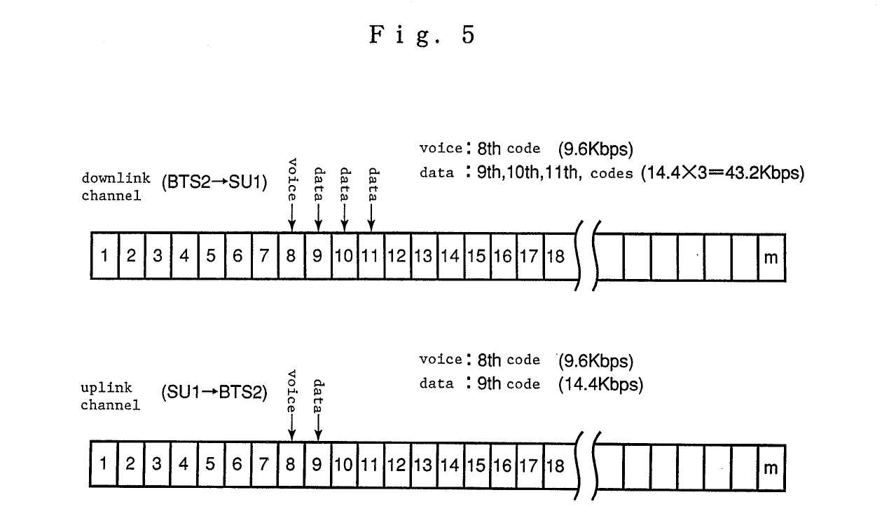

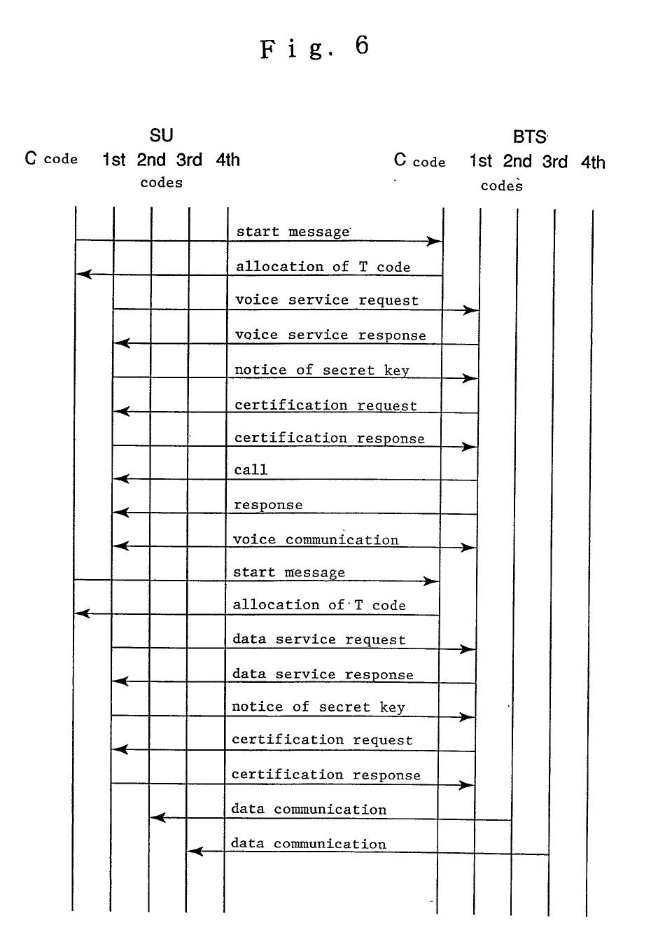

FIG. 5 is a diagram showing a method of specifying a communication code in a radio section between SU 1 and BTS 2 and exemplary transmission rates. Illustrated in FIG. 5 is that both an uplink channel and a downlink channel are assigned one code (9.6 kbps), respectively, for voice communications, while the downlink channel is assigned three codes (43.2 kbps) and the uplink channel is assigned one code (14.4 kbps) for data communications.

FIG. 6 in turn illustrates an exemplary control sequence between SU 1 and WSC 3. Illustrated in FIG. 6 is that an uplink channel and a downlink channel are both assigned one code (9.6 kbps), respectively, for voice communications, while the downlink is assigned three codes (43.2 kbps) and the uplink is assigned one code (14.4 kbps) for data communications.

FIG. 6 illustrates that with the assignment of a code for use with a C (control) code, a voice communication is performed with the first code, and a data communication is performed with the second and third codes. In this example, the voice communication is performed with the first code, and a data service request is also made with the first code. In the code for a voice communication, a format is defined for transmitting control data during a voice communication, so that the data service request is made using this control format.

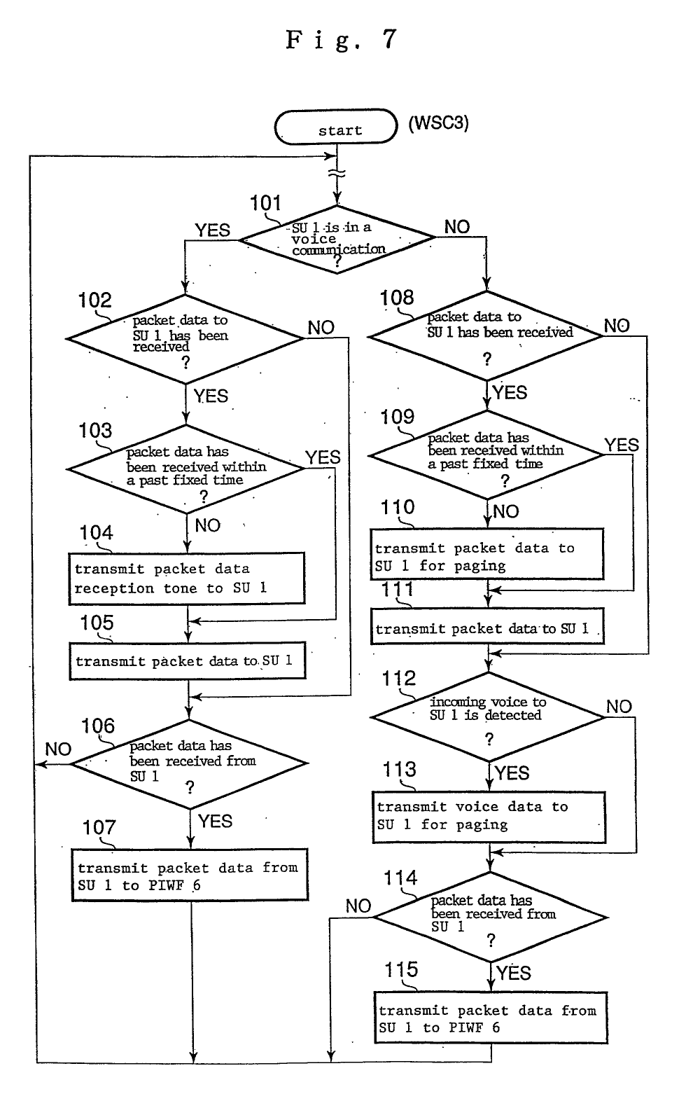

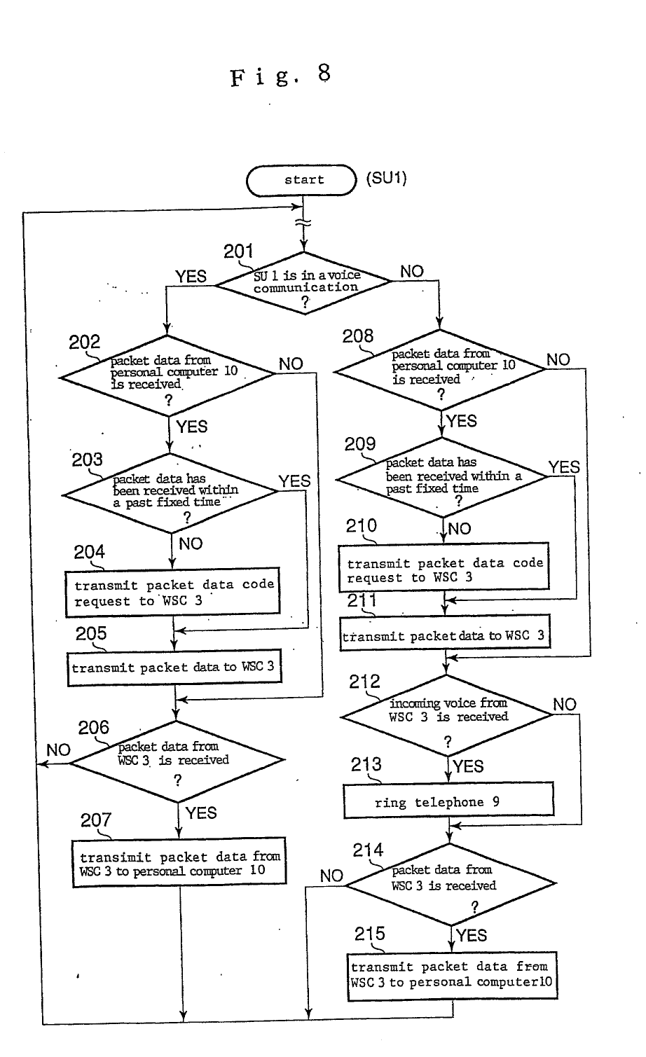

Referring next to FIGS. 7 and 8, description will be made in detail on the operation of the CDMA communication system according to this embodiment, which permits the simultaneous performance of a voice communication and a data communication in a single call.

FIG. 7 is a flow chart for describing the operation of WSC 3. The operation of WSC 3 will be first described with reference to FIG. 7.

Microprocessor 35 in WSC 3 first determines at step 101 determines whether or not SU 1 is currently engaged in a voice communication. When microprocessor 35 determines at step 101 that SU 1 is engaged in a voice communication, microprocessor 35 determines at step 102 whether or not packet data has been received from PIWF 6 to SU 1. When microprocessor 35 determines at step 102 that the packet data has been received from PIWF 6 to SU 1, microprocessor 35 determines at step 103 whether or not the packet data to SU 1 has been received within a past fixed time (for example, within the past five seconds). When microprocessor 35 determines at step 103 that the packet data to SU 1 has not been received within the past fixed time, a packet data reception tone is transmitted to SU 1 at step 104. The packet reception tone used herein refers to a signal for informing SU 1 that packet data is now about to be transmitted. Here, the packet data reception tone is transmitted to SU 1 before transmitting packet data when no packet data has been transmitted within the past fixed time because a code for packet data communication may have previously been used by another subscriber unit if no data packet has been transmitted within the past fixed time, so that a new code must be set.

When microprocessor 35 determines at step 103 that packet data to SU 1 has been received within the past fixed time, or after the packet reception tone is sent to SU 1 at step 104, the received packet data is transmitted to SU 1 from PIWF 6 at step 105. At this step 105, since SU 1 has already been engaged in a voice communication, a call must have been previously set between SU 1 and WSC 3, so that the packet data can be transmitted to SU 1 without setting a new call.

In WSC 3, when microprocessor 35 determines at step 106 that the packet data has been received from SU 1, the packet data received from SU 1 is transmitted to PIWF 6 at step 107.

When microprocessor 35 at step 101 determines that SU 1 is not engaged in a voice communication, and when the data packet has been received from PIWF 6 to SU 1, microprocessor 35 determines at step 109 whether or not packet data to SU 1 has been received within a past fixed time (for example, within the past five seconds). When microprocessor 35 determines at step 109 that no packet data to SU 1 has been received within the past fixed time, packet data is transmitted to SU 1 for paging at step 110. The transmission for paging used herein means that SU 1 is called to connect a call before data is transmitted. The transmission for paging is performed at step 111 in this manner because no call has been connected between SU 1 and WSC 3 due to SU 1 not being engaged in a voice communication. Then, when microprocessor 35 at step 109 determines that packet data to SU 1 has been received within the past predetermined time, or after the packet data is transmitted to SU 1 for paging at step 110, the received packet data is transmitted to SU 1 at step 111.

When an incoming voice to SU 1 is detected at step 112, WSC 3 transmits packet data to SU 1 for paging at step 113. Also, when WSC 3 receives packet data from SU 1 at step 114, the packet data received from SU 1 is transmitted to PIWF 6 at step 115.

FIG. 8 is a flow chart for describing the operation of SU 1. The operation of SU 1 will be described with reference to FIG. 8.

SU controller 17 in SU 1 determines at step 201 whether or not SU 1 is currently engaged in a voice communication. When SU controller 17 determines at step 201 that SU 1 is currently engaged in a voice communication, SU controller 17 determines at step 202 whether or not packet data is being received from personal computer 10. When SU controller 17 determines at step 202 that packet data is being received from personal computer 10, SU controller 17 determines at step 203 whether or not the packet data from personal computer 10 has been received within a past fixed time (for example, within the past five seconds). When SU controller 17 determines at step 203 that the packet data from personal computer 10 has not been received within the past fixed time, a packet data code request is transmitted to WSC 3 at step 204.

Conversely, when SU controller 17 determines at step 203 that the packet data from personal computer 10 has been received within the past fixed time, or after the packet data code request is sent to WSC 3 at step 204, packet data is transmitted from personal computer 10 to WSC 3 at step 205.

When SU 1 receives the packet data from WSC 3 at step 206, the packet data received from WSC 3 is transmitted to personal computer 10 at step 207.

When SU controller 17 determines at step 201 that SU 1 is not currently engaged in a voice communication, SU controller 17 determines at step 208 whether or not packet data from personal computer 10 has been received. When SU controller 17 determines at step 208 that SU 1 is receiving packet data from personal computer 10, SU controller 17 again determines at step 209 whether or not the packet data from personal computer 10 has been received within a past fixed time (for example, within past five seconds). When SU controller 17 determines at step 209 that the packet data from personal computer 10 has not been received within the past fixed time, a packet data code request is made to WSC 3 at step 210. Conversely, when SU controller 17 determines at step 209 that the packet data from personal computer 10 has been received within the past fixed time, or after the packet data code request is sent to WSC 3 at step 210, the received data packet is transmitted to WSC 3 at step 211.

When SU 1 receives an incoming voice from WSC 3 at step 212, SU 1 rings telephone 9 at step 213. Further, when SU 1 receives packet data from WSC 3 at step 214, SU 1 transmits the packet data received from WSC 3 to personal computer 10 at step 215.

Next, the operation of this embodiment will be described for the following cases: when a data communication to a subscriber arrives during a voice communication; when data is originated by a subscriber during a voice communication; when a voice communication arrives during a data communication; and when data is originated by a subscriber during a data communication.

(1) When a data communication to a subscriber arrives during a voice communication:

Upon receipt of packet data for personal computer 10 from ISP 8 while telephone 9 is engaged in a voice communication with telephone 5 through SU 1, PIWF 6 searches for MIN of SU 1 corresponding to the IP (Internet Protocol) address, and notifies SU 1 of incoming packets using a radio control channel. Upon receipt of the notification of incoming packets from WSC 3, SU 1 transmits a packet arrival message to personal computer 10, and transmits a packet arrival response message to WSC 3 upon confirmation of a response from personal computer 10. WSC 3 assigns a multicode for the packet data based on the amount of packet data received by PIWF 6 for personal computer 10 and the availability of a radio channel, and notifies SU 1 of the assigned multicode. Then, WSC 3 transmits, using the multicode, the packet data received by PIWF 6 from ISP 8 to SU 1 as packet data for personal computer 10. PIWF 6 also counts the number of received packets to personal computer 10, and saves the counted number as accounting data. SU 1 simultaneously performs a voice communication and a data communication using the multicode notified from WSC 3.

(2) When a subscriber originates data during a voice communication:

When personal computer 10 transmits packet data to ISP 8 while telephone 9 is engaged in a voice communication with telephone 5 through SU 1, SU 1 requests WSC 3 to assign a multicode using a radio control channel based on the amount of packet data, together with a packet origination message. Upon receipt of the packet origination message from SU 1, WSC 3 transmits the packet origination message to PIWF 6, and upon confirmation of a response from PIWF 6, assigns a multicode for packet data depending on the availability of the radio channel, notifies SU 1 of the assignment of the multicode together with a packet origination response message, and receives packet data from SU 1 using the assigned multicode. WSC 3 transmits the packet data received from SU 1 to PIWF 6 which transmits the packet data received from SU 1 to ISP 8, in accordance with the IP address, through Internet 7. PIWF 6 also counts the number of packets received from personal computer 10, and saves the counted number as accounting data.

(3) When a voice communication arrives during a data communication:

When WSC 3 detects an incoming call from telephone 5 to telephone 9 while personal computer 10 and ISP 8 are communicating packet data through SU 1, WSC 3 notifies SU 1 of the incoming call through the radio control channel using MIN of SU 1. Upon receipt of a call arrival message from WSC 3, SU 1 transmits ringing (ringing signal) to telephone 9, and upon confirmation of a response from telephone 9, transmits a telephone arrival response message to WSC 3. WSC 3 assigns a code for a telephone communication, notifies SU 1 of the assignment of the code, returns a response signal to telephone 5, and connects a line from telephone 5 to telephone 9. Also, independently of the telephone connection with telephone 9, PIWF 6 measures the numbers of transmitted and received packets between personal computer 10 and PIWF 6, and saves the counted numbers as accounting data.

(4) When a subscriber originates data during a data communication:

When SU 1 detects data originated from telephone 5 to telephone 9 while personal computer 10 and ISP 8 are communicating packet data through SU 1, SU 1 notifies placement of a call using the control channel. Upon receipt of a call placement message from SU 1, WSC 3 assigns a code to SU 1, transmits the call placed for telephone 9 and the telephone number of telephone 5 to LS 4, and connects a line to LS 4. Also, independently of the connection with telephone 9 for the call, PIWF 6 counts the numbers of packets transmitted and received between personal computer 10 and PIWF 6, and saves the counted numbers as accounting data.

As described above, according to the CDMA communication system of the foregoing embodiment, since a data call and a voice call can be set for the same MIN, an incoming call of one type can be accepted during a communication for the other type of call, and a call of one type can be placed during a communication for the other type of call. Further, since a data call and a voice call can be set for the same MIN, MIN is efficiently assigned to SU.

The foregoing embodiment is characterized by the ability to simultaneously perform a voice communication and a data communication in the same call in a CDMA system. Additionally, since the WSC manages voice calls and data calls for each SU, the foregoing embodiment can also regulate outgoing and incoming voice calls as well as outgoing and incoming data calls for each SU through an appropriate application of the WSC.

For example, when a subscriber in a service area of a base station is specified as a subscriber subjected to the regulation for incoming data calls, an incoming data call may be regulated when it is received during a voice communication. Also, when a subscriber is specified as a subscriber subjected to the regulation for outgoing data calls, an outgoing data call may be regulated when it is intended during a voice communication. Further, when a subscriber in a service area of a base station is specified as a subscriber subjected to the regulation for incoming voice communications, an incoming voice communication is regulated if it arrives during a data call communication. Also, when a subscriber is specified as a subscriber subjected to the regulation for outgoing voice communications, an outgoing voice call may be regulated when it is intended during a data call communication.

While the CDMA communication system of the foregoing embodiment applies the present invention to a CDMA-WLL system, the present invention is not limited to such a system, but may be applied as well to any system which employs a CDMA communication method. For example, the present invention can be applied to a mobile communication system using a CDMA communication method by replacing the SU in the foregoing embodiment with a mobile station (MS) and a personal computer, and replacing the WSC with a base station controller (BSC).

While a preferred embodiment of the present invention has been described using specific terms, such description is for illustrative purposes only, and it is to be understood that changes and variations may be made without departing from the spirit or scope of the following claims.

What is claimed is:

1. A CDMA communication system comprising:
a radio base station;
at least one subscriber unit for performing radio transmission and reception with said radio base station in accordance with a CDMA scheme; and
a controller for connecting a call to said subscriber unit through said radio base station, wherein:
said controller includes means for, responsive to an incoming data communication to said subscriber unit while said subscriber unit is engaged in a voice communication, assigning to a data communication a spread code different from a spread code used in the voice communication, and notifying said subscriber unit of the assigned spread code so that said subscriber unit may perform a data communication using the spread code; means for, responsive to a notice from said subscriber unit indicating that said subscriber unit is to perform a data communication while said subscriber unit is engaged in a voice communication, assigning to the data communication a spread code different from a spread code used in the voice communication, and notifying said subscriber unit of the assigned spread code so that said subscriber unit may perform data communication using the spread code; means for, responsive to an incoming voice communication to said subscriber unit while said subscriber unit is engaged in a data communication, assigning to the voice communication a spread code different from a spread code used in the data communication, and notifying said subscriber unit of the assigned spread code so that said subscriber unit may perform a voice communication using the spread code; and means for, responsive to a notice from said subscriber unit indicating that said subscriber unit is to perform a voice communicate a voice while said subscriber unit is engaged in a data communication, assigning to the voice communication a spread code different from a spread code used in the data communication, and notifying said subscriber unit of the assigned spread code so that said subscriber unit may perform a voice communication using the spread code,
said subscriber unit includes means for, when intending to perform a data communication during a voice communication, notifying said controller that said subscriber unit wishes to perform a data communication, and performing the data communication using a spread code assigned by said controller; means for, responsive to a spread code for a data communication notified from said controller during a voice communication, performing the data communication using the notified spread code; means for, when intending to perform a voice communication during a data communication, notifying said controller that said subscriber wishes to perform a voice communication, and performing a voice communication using a spread code assigned by said controller; and means for, responsive to a spread code for a voice communication notified from said controller during a data communication, performing a voice communication using the notified spread code.

2. The CDMA communication system according to claim 1, wherein said controller includes means for determining the number of spread codes assigned to a data communication based on the amount of packet data to be transmitted, and availability of a radio channel.

3. A CDMA communication method for communicating between a subscriber unit and a controller in a CDMA communication system, wherein said subscriber unit performs radio transmission and reception with a radio base station in accordance with a CDMA scheme, and said controller connects a call to said subscriber unit through said radio base station, said method comprising the steps of:
when said controller receives a data communication to said subscriber unit while said subscriber unit is engaged in a voice communication, assigning to the data communication a spread code different from a spread code used in the voice communication, notifying said subscriber unit of the assigned spread code so that said subscriber unit communicates data using the spread code;
when said controller receives a notice from said subscriber unit indicating that said subscriber unit is to perform a data communication while said subscriber unit is engaged in a voice communication, assigning to the data communication a spread code different from a spread code used in the voice communication, notifying said subscriber unit of the assigned spread code so that said subscriber unit may perform a data communication using the spread code;
when said controller receives a voice communication to said subscriber unit while said subscriber unit is engaged in a data communication, assigning to the voice communication a spread code different from a spread code used in the data communication, notifying said subscriber unit of the assigned spread code so that said subscriber unit may perform a voice communication using the spread code; and
when said controller receives a notice from said subscriber unit indicating that said subscriber unit is to perform a voice communication while said subscriber unit is engaged in a data communication, assigning to the voice communication a spread code different from a spread code used in the data communication, notifying said subscriber unit of the assigned spread code so that said subscriber unit may perform a voice communication using the spread code.

4. The CDMA communication method according to claim 3, further comprising the steps of determining the number of spread codes assigned to a data communication based on the amount of packet data to be transmitted, and availability of a radio channel.
